(19) United States
(12) Patent Application Publication
(10) Pub. No.: US 2026/0340406 A1
(43) Pub. Date: Oct. 29, 2026

(54) DEEP IMITATION LEARNING FOR RESPONSE SELECTION AND MODEL TRAINING

(71) Applicant: International Business Machines Corporation, Armonk, NY (US)

(72) Inventors: Mu Qiao, Belmont, CA (US); Zachary Augustus Silverstein, Georgetown, TX (US); Jeremy R. Fox, Georgetown, TX (US); Martin G. Keen, Cary, NC (US)

(21) Appl. No.: 19/191,726

(22) Filed: Apr. 28, 2025

(51) Int. Cl. G06N 3/092; G06N 3/0475

(52) U.S. Cl. CPC G06N 3/092; G06N 3/0475

(57) ABSTRACT

One or more systems, devices, computer program products and/or computer-implemented methods of use provided herein relate to deep imitation learning for response selection and model training. For example, in various embodiments, a system is provided. The system can comprise a memory that can store computer-executable components. The system can further comprise a processor that can execute the computer-executable components stored in the memory, where the computer-executable components can comprise an access component that can access input data comprising a prompt and data associated with the prompt. The computer-executable components can further comprise a response selection component that can select, based on the input data, a response to the prompt from a collection of responses by employing deep imitation learning.

### BACKGROUND

The subject disclosure relates to deep neural networks and, more specifically, to deep imitation learning for response selection and model training.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable deep imitation learning for response selection and model training are discussed.

According to an embodiment, a system is provided. The system can comprise a memory that can store computer-executable components. The system can further comprise a processor that can execute the computer-executable components stored in the memory, where the computer-executable components can comprise an access component that can access input data comprising a prompt and data associated with the prompt. The computer-executable components can further comprise a response selection component that can select, based on the input data, a response to the prompt from a collection of responses by employing deep imitation learning.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can employ deep imitation learning to select optimal responses to prompts and that can employ deep imitation learning and reinforcement learning to train knowledge-based systems to generate optimal responses to prompts, in accordance with one or more embodiments described herein.

FIG. 2 illustrates another block diagram of an example, non-limiting system that can employ deep imitation learning to select optimal responses to prompts and that can employ deep imitation learning and reinforcement learning to train knowledge-based systems to generate optimal responses to prompts, in accordance with one or more embodiments described herein.

FIG. 3 illustrates example, non-limiting flow diagrams that describe the training and applications of foundation models.

FIG. 4 illustrates a flow diagram of an example, non-limiting method that can employ deep imitation learning to select optimal responses to prompts from a collection of responses generated by a set of knowledge-based systems, in accordance with one or more embodiments described herein.

FIG. 5 illustrates a flow diagram of an example, non-limiting method that can employ deep imitation learning and reinforcement learning to train knowledge-based systems to generate optimal responses to prompts, in accordance with one or more embodiments described herein.

FIG. 6 illustrates a flow diagram of an example, non-limiting AI workflow that can employ deep imitation learning to select optimal responses to prompts and that can employ deep imitation learning and reinforcement learning to train knowledge-based systems to generate optimal responses to prompts, in accordance with one or more embodiments described herein.

FIG. 7 illustrates a flow diagram of an example, non-limiting AI workflow that can train a set of deep neural networks to employ deep imitation learning to select optimal responses to prompts and that can train knowledge-based systems to generate optimal responses to prompts, in accordance with one or more embodiments described herein.

FIG. 8 illustrates another flow diagram of an example, non-limiting AI workflow that can train a set of deep neural networks to employ deep imitation learning to select optimal responses to prompts and that can train knowledge-based systems to generate optimal responses to prompts, in accordance with one or more embodiments described herein.

FIG. 9 illustrates a flow diagram of an example, non-limiting method that can employ deep imitation learning to select optimal responses to prompts and that can employ deep imitation learning and reinforcement learning to train knowledge-based systems to generate optimal responses to prompts, in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

### Definitions

Foundation model: A foundation model (or AI foundation model) is a large artificial intelligence (AI) model trained on vast quantities of unlabeled data at scale, typically via self-supervised learning, resulting in a model that can be adapted to a wide range of downstream tasks.

Deep imitation learning: In deep imitation learning, a deep neural network is trained via learning by demonstration (LbD) to model a distribution of trajectories of decision sequences employed by subject matter experts (SMEs) and to reproduce/replicate the decision sequences.

Reinforcement learning: Reinforcement learning is a machine learning technique where an agent learns decision making by interacting with an environment, receiving rewards or penalties based on its actions and employing the rewards or penalties as feedback to improve future behavior.

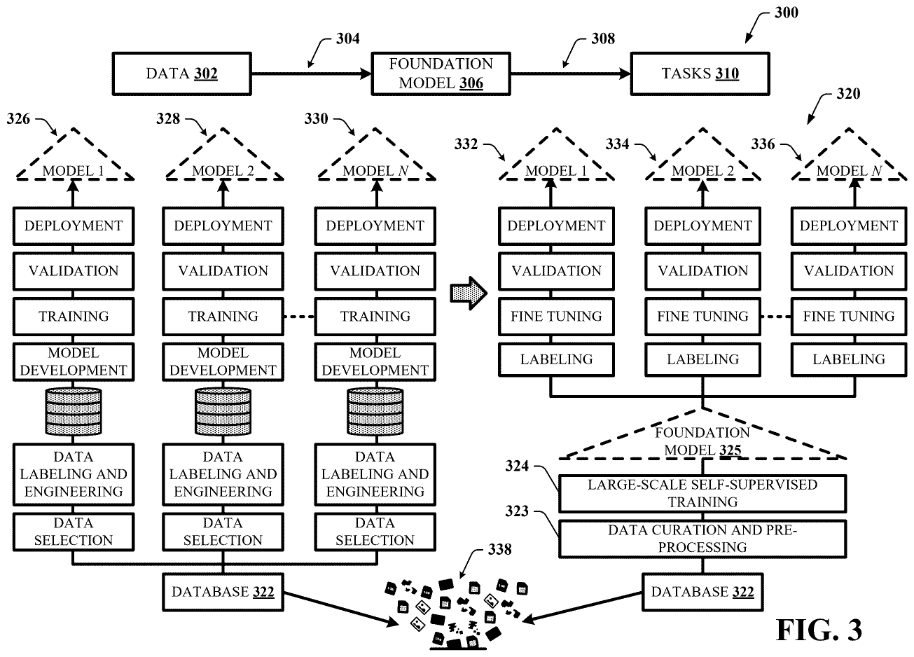

Foundation models are AI models that are pre-trained on large, unlabeled datasets comprising data of different modalities (e.g., language data, time-series data, tabular data, etc.) and that can leverage self-supervised learning to learn generalizable and adaptable data representations that can be effectively employed in multiple downstream tasks (e.g., text generation, machine translation, classification for languages, etc.). Although transformer architectures are most prevalent in foundation models, foundation models are not restricted to specific model architectures. Large language models (LLMs), vision foundation models (VFMs) and audio and speech models are some examples of foundation models. Due to their versatile nature, foundation models are becoming more prominent and are emerging as control points within a new AI workflow (described further with reference to FIG. 3) wherein multiple task-specific models can be effectively generated by fine-tuning a foundation model for different tasks. However, foundation models, and specifically, generative AI models such as LLMs, have some limitations. For example, LLMs are typically trained on data from a certain time frame. For example, ChatGPT® by OpenAI® is trained on data available on the internet until the year 2021. Additionally, the knowledge of a foundation model does not evolve in real time. Finally, although LLMs can exhibit superior performances on certain tasks, such as generative tasks in creative fields, such is not true for all tasks. For example, consider the responses generated by ChatGPT® for Prompts 1, 2 and 3 and the responses generated by ChatGPT® and the Google® search engine for Prompts 4, 5 and 6 directed to learning the subject of quantum computing. It should be understood that the responses provided below for Prompts 1-6 include minor edits and corrections to the original content, which do not affect the substance or intended meaning of the original responses.

Prompt 1: What is the weather like in San Jose, CA in the next 5 days?

ChatGPT® response to Prompt 1: I'm sorry, but as an AI language model, I don't have access to real-time weather information. However, you can check the weather forecast for San Jose, CA on various websites such as Weather.com, Accuweather.com, or the National Weather Service website. These sites provide up-to-date weather information and forecasts for the next few days. You can also download a weather app on your mobile device to get real-time weather updates for your location.

Prompt 2: What is the average stock price of IBM® in Q1, 2023?

ChatGPT® response to Prompt 2: As an AI language model, I don't have access to information from the future, and stock prices can fluctuate widely and rapidly based on a variety of factors. Therefore, I cannot provide an accurate answer to your question about the average stock price of IBM® in Q1 2023. It's important to note that stock prices are subject to market forces, including supply and demand, investor sentiment, economic indicators, and company performance, among others. You can check financial news websites or consult a financial advisor for more information on the current stock prices of IBM® and predictions for future performance.

Prompt 3: Write a poem about Spring within 100 characters.

ChatGPT® response to Prompt 3: Birds chirp, buds bloom,
Nature wakes from winter's gloom.
Spring's arrival, life resumes.

Prompt 4: Explain quantum computing in simple terms.

ChatGPT® response to Prompt 4: Quantum computing is a type of computing that uses the principles of quantum physics to process information. In traditional computing, information is processed using bits, which can only be in one of two states: 0 or 1. However, in quantum computing, information is processed using quantum bits, or qubits, which can be in multiple states at the same time. This allows quantum computers to perform certain types of calculations much faster than traditional computers. One important concept in quantum computing is “superposition,” which means that a qubit can exist in multiple states simultaneously. Another important concept is “entanglement,” which means that qubits can be linked together in a way that their states are correlated, even when they are physically separated. Quantum computers have the potential to revolutionize fields such as cryptography, pharmaceutical discovery, and artificial intelligence. However, they are still in the early stages of development and are not yet widely available.

Google Search response to Prompt 4: Quantum computing is an area of computer science focused on the development of technologies based on the principles of quantum theory. Quantum computing uses the unique behaviors of quantum physics to solve problems that are too complex for classical computing.

Prompt 5: Which company has the quantum computer with the most qubits?

ChatGPT® response to Prompt 5: As of my knowledge cutoff date of September 2021, IBM® had the quantum computer with the most qubits publicly available for use, with their 27-qubit IBM® Quantum System One. However, other companies such as Google®, Rigetti®, and lonQ® are also actively developing quantum computers with increasingly larger numbers of qubits, and the situation may have changed since then. It's also worth noting that the number of qubits is not the only factor that determines the capabilities of a quantum computer, as other factors such as the quality of the qubits and the ability to reduce error rates are also important considerations.

Google Search response to Prompt 5: IBM® has built the largest quantum computer yet. Dubbed Osprey, it has 433 qubits, or quantum bits, which is more than triple the size of the company's previously record-breaking 127-qubit computer and more than eight times larger than Google's 53-qubit computer Sycamore.

Prompt 6: Is the quantum qubits the more the better?

ChatGPT® response to Prompt 6: In quantum computing, the number of qubits in a quantum computer is an important factor, but it is not necessarily true that “more is always better.” The number of qubits in a quantum computer determines the size and complexity of the problems that it can solve, but other factors such as the quality of the qubits, the error rates, and the ability to perform quantum error correction are also important considerations. While increasing the number of qubits can increase the computational power of a quantum computer, it also increases the complexity of maintaining and controlling the system, which can lead to higher error rates and other challenges. Therefore, simply adding more qubits to a quantum computer may not always lead to better performance, and researchers and engineers need to carefully balance the number of qubits with other factors such as the quality of the qubits and the ability to reduce error rates. In general, the optimal number of qubits for a particular problem depends on the specific characteristics of the problem and the available resources, and it is an active area of research to determine how to effectively design and optimize quantum algorithms for different applications.

Google Search response to Prompt 6: Google Search showed an online discussion under the title, “Why can qubits be more useful than bits?”

Evidently, the generative AI-based responses to Prompts 1-3 are not the most informative or optimal. Although the responses generated by ChatGPT® for Prompts 4 and 6 are informative, relevant and more detailed as compared to the responses generated by Google Search, comparing the responses generated by ChatGPT® and Google Search for Prompt 5 can reveal that foundation models often do not have access to the latest information.

ChatGPT® can also formulate a query for Wolfram|Alpha®, forward the query to Wolfram|Alpha® for computation, and generate a response to the query by reading the results received from Wolfram|Alpha®. For example, when prompted to identify the distance from Chicago to Tokyo (e.g., “How far is it from Chicago to Tokyo?”), ChatGPT® responded with, “The distance between Chicago and Tokyo is approximately 6,313 miles (10,160 kilometers). Traveling by plane at an average speed of 550 mph would take around 11 hours and 30 minutes to cover this distance.” Bing® AI Chat by Bing® is yet another generative AI-based tool that can iteratively generate a set of internal queries through a component called Bing Orchestrator by leveraging Bing index, ranking and advanced generative pre-trained transformer (GPT) models by OpenAI®. However, even though existing generative AI-based tools can employ foundation models to generate queries and responses, these existing techniques often do not ensure that the responses generated by foundation models such as LLMs are optimal (e.g., accurate) for a given prompt, and the foundation models are often not iteratively updated or retrained on the latest information. Thus, methods and techniques that can enable LLMs respond to a prompt (e.g., a set of questions and/or instructions) provided by an end entity (e.g., hardware, software, machine, AI, neural network and/or user) with the optimal answer and that can be employed to iteratively update or retrain LLMs with new information and knowledge are desirable.

Various embodiments of the present disclosure can be implemented to produce a solution to these problems. Embodiments described herein include systems, computer-implemented methods, and computer program products that can employ deep imitation learning for response selection and model training. For example, given a question or a prompt (e.g., a question or an instruction) from a sequence of prompts (e.g., a sequence of questions or instructions), the embodiments of the present disclosure can employ a set of deep neural networks trained on deep imitation learning to select an optimal response to the prompt, from a collection of responses, via the deep imitation learning. The set of trained deep neural networks can be further employed in conjunction with reinforcement learning to update or retrain one or more foundation models based on feedback from SMEs to ensure that the one or more foundation models can generate more optimal responses to prompts.

Specifically, in one or more embodiments, a deep imitation learning model is provided. Given input data comprising a prompt selected from a sequence of prompts and further comprising additional data associated with the prompt, the deep imitation learning model can employ a response selection component to select, via deep imitation learning, a response to the prompt from a collection of responses, wherein the response can represent an optimal response to the prompt. The collection of responses can comprise a plurality of responses generated by a set of knowledge-based systems, based on the prompt, and the set of knowledge-based systems can comprise one or more foundation models (e.g., one or more LLMs or other foundation models), one or more IR systems and/or other types of knowledge-based systems.

In one or more embodiments, the response selection component can be trained by a training component to select the response via the deep imitation learning. For example, SMEs (e.g., human experts) can be prompted by a prompt component to provide raw feedback on one or more responses selected by the response selection component based on one or more past prompts (i.e., prompts previously processed by deep imitation learning model). As part of the raw feedback, the SMEs can identify preferred responses for the one or more past prompts from the collection of responses and demonstrate decision sequences employable to select the preferred responses. In some embodiments, the SMEs can be human experts, whereas in other embodiments, the SMEs can be hardware, software, machines, AI and/or neural networks. The raw feedback can be aggregated, pre-processed and converted by a data aggregation component into feedback data, wherein the feedback data can have a format employed by the training component to train a set of deep neural networks comprised within the response selection component. As such, training component can train the set of deep neural networks on the feedback data to access input data comprising a prompt and data associated with the prompt and to select, based on the input data, an optimal response to the prompt by replicating the decision sequences demonstrated by the SMEs. The data associated with the prompt can comprise an end entity profile associated with an end entity (e.g., hardware, software, machine, AI, neural network and/or user) that provides the input data to the deep imitation learning model, a time stamp associated with the prompt, contextual information (e.g., a previously selected response), etc.

In one or more embodiments, the training component can also retrain one or more foundation models comprised within the set of knowledge-based systems via the deep imitation learning and reinforcement learning based on supervision and feedback from the SMEs. For example, the training component can retrain one or more LLMs on the feedback data to generate more accurate responses to future prompts, wherein the feedback data can comprise SME supervisions such as preferred responses identified by an SME for a past prompt. More specifically, the training component can convert feedback comprised within the feedback data into reward signals. For example, the training component can convert positive feedback comprised within the feedback data into positive signals and convert negative feedback comprised within the feedback data into negative signals. Thus, the reward signals can comprise positive and negative signals, and the training component can retrain the one or more LLMs on the reward signals, via reinforcement learning.

The embodiments of the present disclosure can provide significant business value to an organization by improving the performances of existing AI-based systems. While some of the existing techniques in the art involve interactions between a GPT model and an information retrieval (IR) system, the embodiments of the present disclosure can expand response generation to a collection of N arbitrary models, including LLMs, IR systems, and other types of knowledge-based systems, wherein N represents a positive integer. Additionally, the embodiments of the present disclosure can provide technical improvements to generative AI-based systems by training generative AI-based systems to generate more optimal and relevant responses to prompts and by automatically and iteratively retraining the generative AI-based systems, based on feedback from SMEs on the responses, to generate more optimal responses to new prompts.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

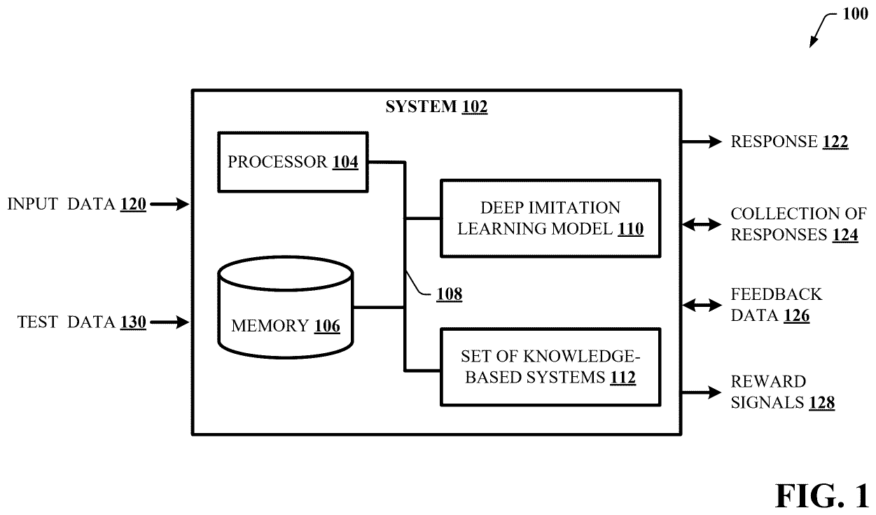

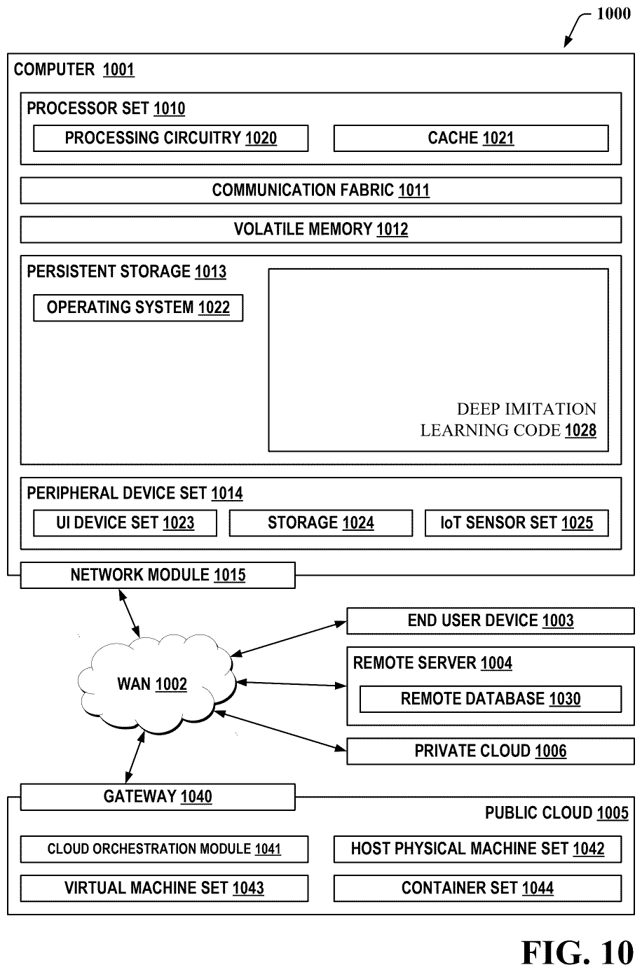

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1000 illustrated at FIG. 10. For example, non-limiting system 100 can be associated with, such as accessible via, computing environment 1000 described below with reference to FIG. 10, such that aspects of processing can be distributed between non-limiting system 100 and the computing environment 1000. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can employ deep imitation learning to select optimal responses to prompts and that can employ deep imitation learning and reinforcement learning to train knowledge-based systems to generate optimal responses to prompts, in accordance with one or more embodiments described herein.

Non-limiting system 100 and/or the components of non-limiting system 100 can be employed to use hardware and/or software to solve problems that are highly technical in nature (e.g., related to neural networks, deep imitation learning, reinforcement learning, etc.), that are not abstract and that cannot be performed as a set of mental acts by a human. Further, some of the processes performed may be performed by specialized computers for carrying out defined tasks related to deep imitation learning for response selection and model training. Non-limiting system 100 and/or components of non-limiting system 100 can be employed to solve new problems that arise through advancements in technologies mentioned above, and/or the like. Non-limiting system 100 can provide technical improvements to generative AI-based systems by training generative AI-based systems to generate more optimal and relevant responses to prompts and by automatically and iteratively retraining the generative AI-based systems, based on feedback from SMEs on the responses, to generate more optimal responses to new prompts.

In one or more embodiments, non-limiting system 100 can comprise system 102. Discussion turns briefly to processor 104, memory 106 and bus 108 of system 102. For example, in one or more embodiments, system 102 can comprise processor 104 (e.g., computer processing unit, microprocessor, classical processor, and/or like processor). In one or more embodiments, a component associated with system 102, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, system 102 can comprise a computer-readable memory (e.g., memory 106) that can be operably connected to processor 104. Memory 106 can store computer-executable instructions that, upon execution by processor 104, can cause processor 104 and/or one or more other components of system 102 (e.g., deep imitation learning model 110, set of knowledge-based systems 112, access component 202, response selection component 204, training component 206, evaluation component 208, feedback component 210, prompt component 212, storage component 214 and data aggregation component 216) to perform one or more actions. In one or more embodiments, memory 106 can store computer-executable components (e.g., deep imitation learning model 110, set of knowledge-based systems 112, access component 202, response selection component 204, training component 206, evaluation component 208, feedback component 210, prompt component 212, storage component 214 and data aggregation component 216). In one or more embodiments, one or more of the components of system 102 can reside in the cloud, and/or can reside locally in a local computing environment (e.g., at a specified location(s)).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network.

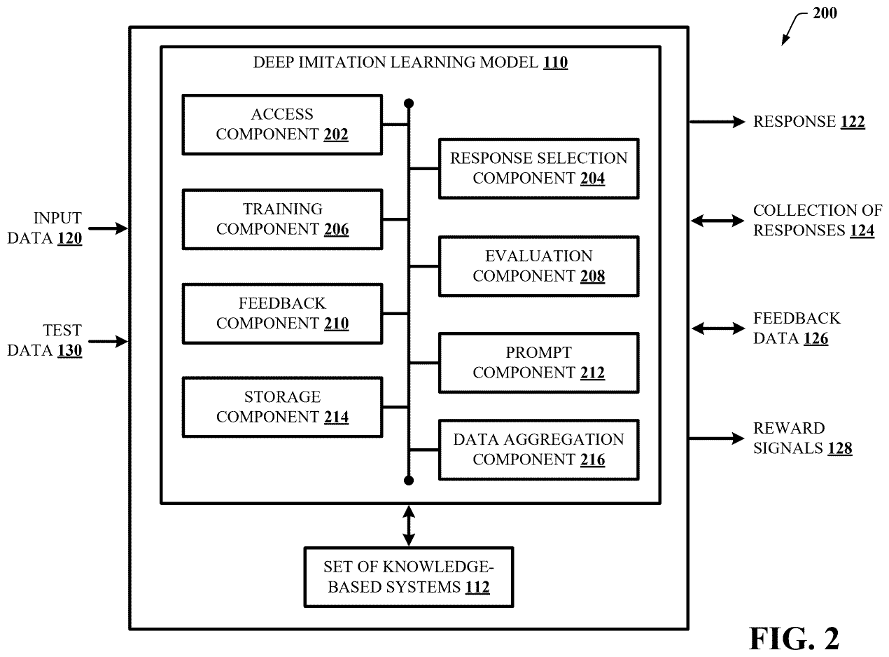

In one or more embodiments, system 102 can comprise deep imitation learning model 110 and set of knowledge-based systems 112. As illustrated in FIG. 2, deep imitation learning model 110 can comprise access component 202, response selection component 204, training component 206, evaluation component 208, feedback component 210, prompt component 212, storage component 214 and data aggregation component 216. Set of knowledge-based systems 112 can comprise one or more foundation models (FMs), one or more information retrieval (IR) systems, and/or other types of knowledge-based systems. Foundation models are large-scale machine learning models that are trained on diverse datasets and that can be adapted for numerous downstream tasks. Foundation models provide a general-purpose base that can be fine-tuned and/or prompted for applications such as question answering, translation, summarization, image captioning, etc. LLMs, VFMs and audio and speech models are some examples of foundation models. In one or more embodiments, set of knowledge-based systems 112 can comprise LLMs and/or other types of foundation models. IR systems are systems designed to store, manage and retrieve, based on queries, relevant information from large datasets. Search engines, digital libraries and enterprise search systems are some examples of IR systems.

In one or more embodiments, deep imitation learning model 110 can generate a response to a prompt (e.g., a set of questions and/or instructions) by selecting an optimal response (i.e., an answer) from a collection of responses generated by set of knowledge-based systems 112. For example, an end entity (e.g. hardware, software, machine, AI, neural network and/or user) can input a prompt into system 102 via the user interface (UI) of a computing device (e.g., a desktop computer, a laptop, a tablet, a smartphone, etc.). The prompt can be accessed by set of knowledge-based systems 112, and respective systems comprised within set of knowledge-based systems 112 can generate respective responses to the prompt. Deep imitation learning model 110 can access the prompt and the responses generated by set of knowledge-based systems 112 and select, based on the prompt, an optimal response to the prompt from the responses generated by set of knowledge-based systems 112. Deep imitation learning model 110 can output the optimal response to the UI where the optimal response can be viewed by the end entity (e.g., hardware, software, machine, AI, neural network and/or user). In one or more embodiments, deep imitation learning model 110 can employ deep imitation learning, via a set of deep neural networks (i.e., a set of deep imitation learning neural networks), to select the optimal response. Deep imitation learning is a machine learning technique wherein a deep neural network can perform tasks by mapping observations to actions based on demonstration data by training the deep neural networks to replicate expert behavior.

Specifically, in one or more embodiments, access component 202 can access input data 120 comprising a prompt and data associated with the prompt. For example, input data 120 can comprise a prompt input to system 102 by an end entity (e.g., hardware, software, machine, AI, neural network and/or user) and further comprise data associated with the prompt such as an end entity profile (e.g., a user profile) related to the end entity (e.g., hardware, software, machine, AI, neural network and/or user), contextual information (e.g., time stamps, Global Positioning System (GPS) data, etc.) related to the end entity (e.g., hardware, software, machine, AI, neural network and/or user) and/or other relevant data similarly associated with the prompt. In one or more embodiments, response selection component 204 can select, based on input data 120, a response (i.e., response 122) to the prompt from collection of responses 124 by employing deep imitation learning. In this regard, collection of responses 124 can comprise respective responses that can be generated by respective systems (e.g., models) comprised within set of knowledge-based systems 112, based on input data 120, upon access component 202 accessing input data 120. To select response 122 based on input data 120 via the deep imitation learning, response selection component 204 can model a distribution of trajectories of decision sequences previously employed by subject matter experts (SMEs) to select responses to prompts (e.g., prompts similar to the prompt comprised within input data 120). In some embodiments, the SMEs can be human experts, whereas in other embodiments, the SMEs can be hardware, software, machines, AI and/or neural networks.

In one or more embodiments, training component 206 can train response selection component 204 to select response 122 based on input data 120 by modeling the distribution of trajectories of decision sequences employed by the SMEs. For example, training component 206 can access feedback data 126 associated with one or more responses previously selected by response selection component 204 from collection of responses 124, wherein the one or more responses can comprise responses generated by one or more foundation models comprised within set of knowledge-based systems 112, based on one or more past prompts. For example, the one or more responses can comprise responses generated by one or more large language models (LLMs) comprised within set of knowledge-based systems 112 for one or more prompts previously entered into system 102 by an end entity (e.g., hardware, software, machine, AI, neural network and/or user).

Feedback data 126 can comprise trajectories of decision sequences employed by one or more SMEs based on the one or more past prompts. For example, feedback data 126 can comprise respective trajectories of respective decision sequences, wherein a first decision sequence can comprise a set of first decisions employed by a first SME to select (from collection of responses 124) first responses to the one or more past prompts, a second decision sequence can comprise a set of second decisions employed by a second SME to select (from collection of responses 124) second responses to the one or more past prompts, and so on. The trajectories of decision sequences comprised within feedback data 126 can demonstrate the response selection patterns that can be employed by response selection component 204 to select response 122 based on input data 120. Further, response selection component 204 can comprise a set of deep neural networks. Thus, to train response selection component 204 to select responses (e.g., response 122) to prompts, training component 206 can train the set of deep neural networks comprised within response selection component 204 to imitate the decision sequences comprised within feedback data 126 by employing feedback data 126 as the training data for the training. Stated differently, training component 206 can train response selection component 204 to perform deep imitation learning (i.e., to reproduce decision sequences similar to those employed by the SMEs) by training the set of deep neural networks comprised within response selection component 204 on feedback data 126.

In one or more embodiments, feedback data 126 can be generated by feedback component 210 by employing prompt component 212, storage component 214 and data aggregation component 216. For example, prompt component 212 can prompt the one or more SMEs for raw feedback on the one or more responses previously selected by response selection component 204, from collection of responses 124, based on the one or more past prompts. For example, prompt component 212 can prompt an SME to provide raw feedback in the form of ratings, corrections or qualitative feedback on the one or more responses, wherein an SME can provide raw feedback on the one or more responses via the UI (e.g., a graphical user interface (GUI), a command line interface (CLI), etc.) of a computing device (e.g., a desktop computer, a laptop, a tablet, a smartphone, etc.). Storage component 214 can store the one or more past prompts, the one or more responses and the raw feedback in a structured format in a storage (e.g., memory 106). Data aggregation component 216 can aggregate the raw feedback provided by the one or more SMEs and stored in the storage by storage component 214. Further, data aggregation component 216 can pre-process the raw feedback to identify common trends, errors and areas of performance improvements for the one or more LLMs (comprised within set of knowledge-based systems 112) that generated the one or more responses. Finally, data aggregation component 216 can convert a first format associated with the raw feedback into a second format employable by training component 206 to train the set of deep neural networks comprised within response selection component 204, wherein converting the first format into the second format can convert the raw feedback into feedback data 126. For example, the raw feedback can comprise qualitative feedback having a first format, and data aggregation component 216 can convert the qualitative feedback into feedback data 126 having a second format employable for training response selection component 204. For example, data aggregation component 216 can convert a prompt and a corrected response provided by an SME for the prompt into a training pair comprising an input (e.g., the prompt) and an output (e.g., the corrected response).

In one or more embodiments, training component 206 can further train, via the deep imitation learning and reinforcement learning, the one or more foundation models (e.g., the one or more LLMs) comprised within set of knowledge-based systems 112. For example, training component 206 can retrain or update the one or more LLMs by employing the set of deep neural networks and human supervision via reinforcement learning based on human feedback. To retrain or update the one or more LLMs, training component 206 can first convert feedback data 126 into reward signals 128, such that positive feedback comprised within feedback data 126 can be converted to positive signals, and negative feedback (e.g., corrections provided by SMEs) comprised within feedback data 126 can be converted to negative signals (e.g., penalties). Thus, reward signals 128 can comprise positive signals and negative signals. Training component 206 can train the one or more LLMs iteratively, based on reward signals 128, to generate more optimal (e.g., accurate) responses for new prompts (e.g., future prompts). For example, training component 206 can employ reinforcement learning to guide the one or more LLMs towards responses that align more closely with response preferences of the SMEs, based on reward signals 128. Further, training component 206 can iterate upon the training process employed to train the one or more LLMs, thereby continuously refining the one or more LLMs based on an evolving understanding of what constitutes a good response for a given prompt. Training component 206 can implement the reinforcement learning described herein via suitable reinforcement learning algorithms such as Deep Q-Network (DQN), Proximal Policy Optimization (PPO), Soft Actor-Critic (SAC), Twin Delayed Deep Deterministic Policy Gradient (TD3), Asynchronous Advantage Actor-Critic (A3C), etc.

In one or more embodiments, evaluation component 208 can evaluate respective performances of the one or more foundation models (e.g., one or more LLMs) subsequent to the training of the one or more foundation models by training component 206. For example, evaluation component 208 can test the performance of the one or more LLMs on test data 130 by employing certain performance metrics or benchmarks. Additionally, test data 130 can be relevant to the LLM being evaluated by evaluation component 208, such that different LLMs can be evaluated on different test datasets. In an embodiment, evaluation component 208 can test the performance of the LLM via holdout validation based on test data 130. For example, test data 130 can be a held-out dataset comprising data reserved from feedback data 126 for testing, such that test data 130 can comprise data previously unseen by an LLM. In another embodiment, evaluation component 208 can test the performance of the LLM via A/B testing based on test data 130. In machine learning, A/B testing is typically performed after model development or retraining to compare the performance of a new or updated model against a baseline or an existing production model. Further, data aggregation component 216 can continuously monitor the respective performances of the one or more LLMs on new prompts. For example, data aggregation component 216 can continuously monitor end entity satisfaction via raw feedback provided by end entities (e.g., hardware, software, machines, AI, neural networks and/or users) on new responses generated by the one or more LLMs on the new prompts. For example, data aggregation component 216 can pre-process the raw feedback to identify common trends, errors and areas of performance improvements for the one or more LLMs. If new areas of performance improvements are identified by data aggregation component 216 for the one or more LLMs, training component 206 can automatically refine (e.g., update or retrain) the one or more LLMs, and the collection of raw feedback by feedback component 210 can automatically begin anew.

The embodiments of the present disclosure are discussed in greater detail with reference to the subsequent figures.

FIG. 2 illustrates another block diagram of an example, non-limiting system 200 that can employ deep imitation learning to select optimal responses to prompts and that can employ deep imitation learning and reinforcement learning to train knowledge-based systems to generate optimal responses to prompts, in accordance with one or more embodiments described herein. Repetitive description of like elements and/or processes employed in respective embodiments is omitted for sake of brevity.

Non-limiting system 200 illustrates the system of deep imitation learning model 110 and set of knowledge-based systems 112. As discussed with reference to FIG. 1, in one or more embodiments, given input data 120 comprising a prompt (e.g., a set of questions and/or instructions) selected from a sequence of prompts and further comprising additional data associated with the prompt, deep imitation learning model 110 can select, via deep imitation learning, response 122 from collection of responses 124, wherein response 122 can represent an optimal response to the prompt. Collection of responses 124 can comprise responses generated by set of knowledge-based systems 112 based on the prompt, and set of knowledge-based systems 112 can comprise one or more foundation models (e.g., one or more LLMs or other foundation models), one or more IR systems and/or other types of knowledge-based systems.

In one or more embodiments, deep imitation learning model 110 can employ response selection component 204 to select response 122, and response selection component 204 can be trained by training component 206 to select response 122 via the deep imitation learning. For example, SMEs (e.g., human experts) can be prompted by prompt component 212 to provide raw feedback on one or more responses selected by response selection component 204 for one or more past prompts. As part of the raw feedback, the SMEs can identify preferred responses for the one or more past prompts from collection of responses 124 and demonstrate decision sequences employable to select the preferred responses. In some embodiments, the SMEs can be human experts, whereas in other embodiments, the SMEs can be hardware, software, machines, AI and/or neural networks. The raw feedback can be aggregated, pre-processed and converted by data aggregation component 216 into feedback data 126, wherein feedback data 126 can have a format employed by training component 206 to train a set of deep neural networks comprised within response selection component 204. As such, training component 206 can train the set of deep neural networks on feedback data 126 to access inputs (e.g., input data 120) comprising a prompt and data associated with the prompt, and select an optimal response (e.g., response 122) to the prompt by replicating the decision sequences demonstrated by the SMEs. Such training is known as learning by demonstration, and the data associated with the prompt can comprise an end entity profile associated with an end entity (e.g., hardware, software, machine, AI, neural network and/or user) that provides the prompt, a time stamp associated with the prompt, contextual information (e.g., a previously selected response), etc.

In one or more embodiments, training component 206 can also retrain one or more foundation models comprised within set of knowledge-based systems 112, via the deep imitation learning and reinforcement learning, based on supervision and feedback from the SMEs. For example, training component 206 can retrain one or more LLMs on feedback data 126, to generate more accurate responses to future prompts, wherein feedback data 126 can comprise SME supervisions such as preferred responses identified by an SME for a past prompt. More specifically, training component 206 can convert feedback comprised within feedback data 126 into reward signals 128. For example, training component 206 can convert positive feedback comprised within feedback data 126 into positive signals and convert negative feedback comprised within feedback data 126 into negative signals. Thus, reward signals 128 can comprise positive and negative signals, and training component 206 can retrain the one or more LLMs on reward signals 128, via reinforcement learning.

FIG. 3 illustrates example, non-limiting flow diagrams 300 and 320 that describe the training and applications of foundation models.

FIG. 3 is intended to describe the advantages of foundation models in AI workflows.

Non-limiting flow diagram 300 describes how a foundation model can be trained and employed for downstream tasks. In non-limiting flow diagram 300, data 302 can comprise text data, images, speech data, structured data, three-dimensional (3D) signals, and/or other type of data. At 304, foundation model 306 can be trained on data 302, and at 308, foundation model 306 can be adapted (e.g., via minimal additional training) to perform tasks 310. Tasks 310 can comprise downstream tasks such as question answering, sentiment analysis, information extraction, image captioning, object recognition, instruction following, etc.

Non-limiting flow diagram 320 illustrates machine learning workflows. Database 322 can comprise a large amount of data of various formats, similar to data 302. At 338, FIG. 3 illustrates a representation of database 322. Path 326, path 328 and path 330 on the left-hand side of non-limiting flow diagram 320 illustrate a machine learning workflow that does not employ foundation models. Such a workflow can comprise the steps of data selection, data labeling and engineering, model development, training, validation and deployment to generate one or more task-specific models (e.g., model 1, model 2, . . . model N, wherein N represents a positive integer). Data selection can comprise choosing relevant, high-quality data (e.g., from database 322) to train a model, data labeling can comprise annotating the data with correct/accurate outputs, model development can comprise designing an architecture and choosing the algorithms for the model, and training can comprise feeding the data to the model so that the model can learn patterns and relationships. Upon training, the model can be validated and deployed. Validation can comprise testing the model on data different from the training data to evaluate a performance of the model and adjust the model's parameters, and deployment can comprise integrating the trained model into real-world applications or systems for practical uses.

Path 332, path 334 and path 336 on the right-hand side of non-limiting flow diagram 320 illustrate an emerging AI workflow based on foundation models. Such a workflow can comprise, at 323, data curation and pre-processing of data selected from database 322, and at 324, large-scale self-supervised training, to generate foundation model 325. Foundation model 325 can be further employed to generate one or more task-specific models (e.g., model 1, model 2, . . . model N, wherein N represents a positive integer), wherein the process of generating the one or more task-specific models can comprise the steps of data labeling, fine-tuning, validation and deployment. Since foundation model 325 can comprehend different domains due to being trained on database 322, foundation model 325 can be adapted for specific tasks by employing significantly less task-specific data as compared to workflows that do not employ foundation models. Thus, in comparison to the workflow illustrated by paths 326, 328 and 330, the foundation model-based workflow can involve a 10-100 times (10-100×) smaller/lesser effort in labeling the task-specific data. After the labeling stage, foundation model 325 can be fine-tuned on the task-specific data to adapt foundation model 325 to specific domains, improve performance of foundation model 325, reduce hallucinations or bias in outputs, etc. Fine-tuning foundation model 325 can generate a new model (e.g., model 1, model 2, . . . model N, wherein N represents a positive integer), that can be validated and deployed.

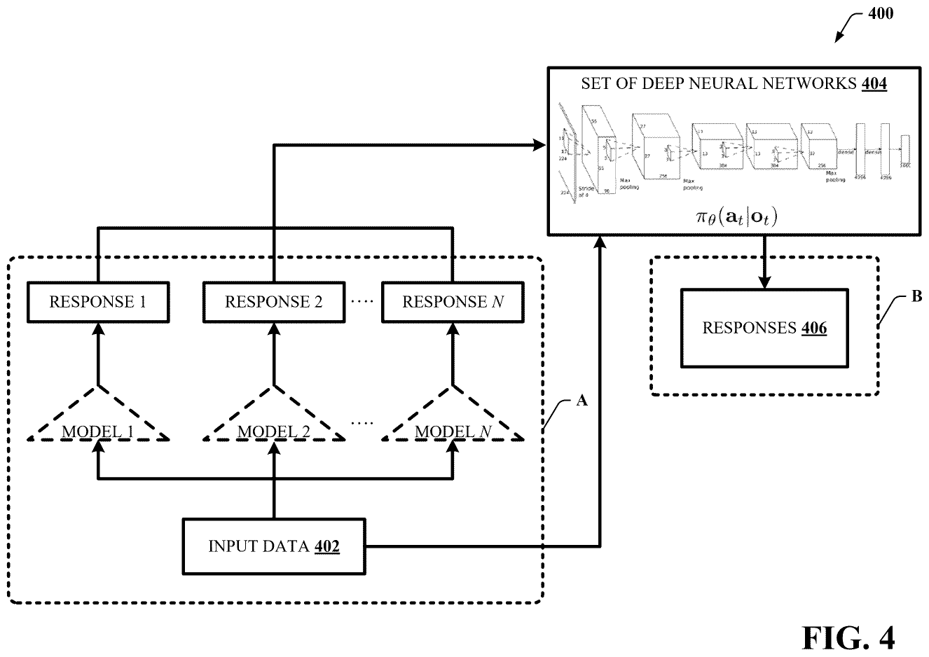

FIG. 4 illustrates a flow diagram of an example, non-limiting method 400 that can employ deep imitation learning to select optimal responses to prompts from a collection of responses generated by a set of knowledge-based systems, in accordance with one or more embodiments described herein. Repetitive description of like elements and/or processes employed in respective embodiments is omitted for sake of brevity.

With continued reference to FIGS. 1 and 2, in non-limiting method 400, input data 402 can be analogous to input data 120, such that input data 402 can comprise prompts (e.g., a set of questions and/or instructions) and data associated with the prompts. Further, model 1, model 2, . . . , model N can be knowledge-based systems (e.g., foundation models, IR systems, etc.) comprised within set of knowledge-based systems 112, and response 1, response 2, . . . , response N can be responses comprised within collection of responses 124, wherein N can represent a positive integer. Input data 402 can be input to system 102 by an end entity (e.g., hardware, software, machine, AI, neural network and/or user) via the UI of a computing device (e.g., a desktop computer, a laptop, a tablet, a smartphone, etc.), and response 1, response 2, . . . , response N can be generated by model 1, model 2, . . . , model N, respectively, based on input data 402. Thus, collection of responses 124 can comprise N responses from N models.

In one or more embodiments, set of deep neural networks 404 can represent the set of deep neural networks comprised within response selection component 204 that can select, via deep imitation learning, responses 406 from collection of responses 124, based on input data 402. Responses 406 can comprise one or more responses to the prompt comprised within input data 402. In this regard, block A can represent an observation space Oₜ comprising input data 402, and block B can represent an action space aₜ comprising responses 406. The prompts comprised within input data 402 can be represented as [v₀, v₁, v₂, v₃, v₄, v₅, . . . , vₘ], and responses 406 can be represented as [a₀, a₁, a₂, a₃, a₄, a₅, . . . , aₙ]. In machine learning, defining a reward function that can be employed by set of deep neural networks 404 to select responses 406 generated by different models (e.g., LLMs, IR systems, etc.) can be challenging. Learning by demonstration, also known as deep imitation learning, is a technique that can be employed to bootstrap or supplement deep reinforcement learning when a reward function is unknown or difficult to estimate. Accordingly, in one or more embodiments, set of deep neural networks 404 can be trained by training component 206 on feedback data 126 to learn by demonstration. As a result, set of deep neural networks 404 can be trained to model distributions of trajectories of decision sequences employed by SMEs (e.g., expert trajectories) in selecting responses to prompts. Subsequent to the training, set of deep neural networks 404 (i.e., the resulting trained model) can select responses 406 based on input data 402 by reproducing the decision sequences employed by the SMEs.

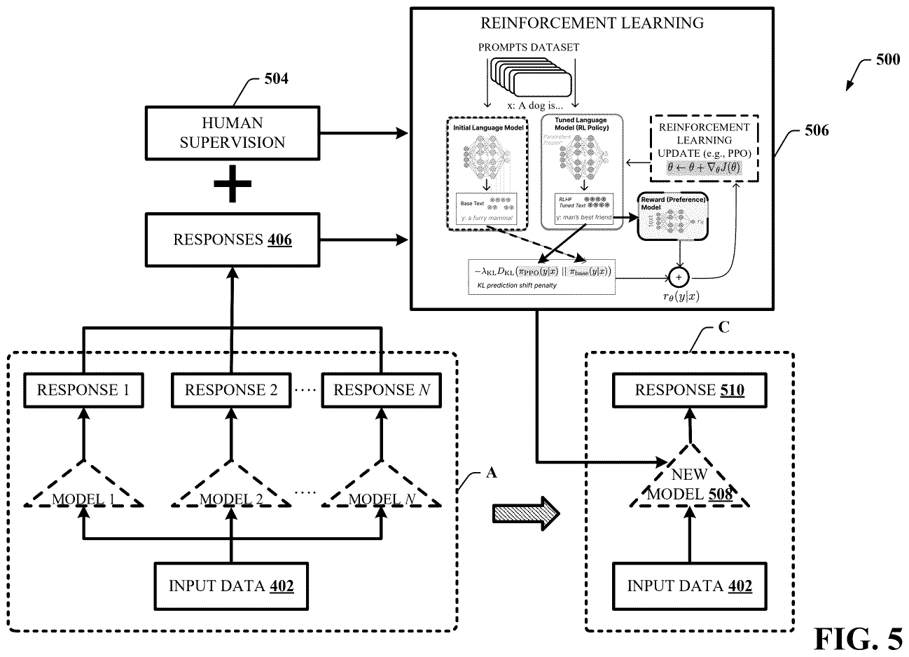

FIG. 5 illustrates a flow diagram of an example, non-limiting method 500 that can employ deep imitation learning and reinforcement learning to train knowledge-based systems to generate optimal responses to prompts, in accordance with one or more embodiments described herein. Repetitive description of like elements and/or processes employed in respective embodiments is omitted for sake of brevity.

With continued reference to FIGS. 1, 2 and 4, non-limiting method 500 describes how responses 406 can be employed to update one or more models comprised within set of knowledge-based systems 112. For example, responses 406 can be employed to balance and retrain one or more LLMs to ensure that the one or more LLMs generate optimal responses to prompts. For example, at 504 in non-limiting method 500, responses 406 can be subject to supervision by SMEs. In some embodiments, the SMEs can be human experts, whereas in other embodiments, the SMEs can be hardware, software, machines, AI and/or neural networks. For example, prompt component 212 can prompt one or more SMEs to provide raw feedback on responses 406. Each SME can provide raw feedback on responses 406 via the UI (e.g., a GUI, a CLI, etc.) of a computing device (e.g., a desktop computer, a laptop, a tablet, a smartphone, etc.), and storage component 214 can store raw feedback from different SMEs in a storage (e.g., memory 106) in a structured format.

Data aggregation component 216 can, over time, aggregate the raw feedback from multiple SMEs and pre-process the raw feedback to identify common trends, errors and areas of performance improvements for one or more models (e.g., model 1, model 2, . . . , model N) comprised within set of knowledge-based systems 112. Further, data aggregation component 216 can convert the raw feedback into feedback data 126, wherein feedback data 126 can have a format employable by training component 206 to train the one or more models. For example, the raw feedback provided by an SME can comprise a correct response to a prompt comprised within input data 402, such that the correct response can be different from the response selected by set of deep neural networks 404 for the prompt. For example, model 1 comprised within set of knowledge-based systems 112 can generate response 1 based on prompt P1, and set of deep neural networks 404 can select response 1 as the best response available for prompt P1 from collection of responses 124. However, an SME can provide raw feedback comprising corrections to response 1 to make response 1 more accurate. Alternatively, the raw feedback by the SME can indicate that a different response from collection of responses 124 should have been the more accurate response for prompt P1. Based on the raw feedback, data aggregation component 216 can convert prompt P1 and the corrected response provided by the SME into a training pair comprising an input (e.g., prompt P1) and an output (e.g., the corrected response).

At 506 in non-limiting method 500, training component 206 can employ feedback data 126 based on responses 406 selected via deep imitation learning to train, via reinforcement learning, one or more models (e.g., model 1, model 2, . . . , model N) comprised within set of knowledge-based systems 112. For example, training component 206 can convert feedback data 126 into reward signals 128, such that positive feedback comprised within feedback data 126 can be converted to positive signals, and negative feedback comprised within feedback data 126 can be converted to negative signals. Training component 206 can employ reward signals 128, via reinforcement learning, to guide the one or more models towards responses that align more closely with response preferences indicated by the SMEs. For example, model 1 can be an LLM, and the raw feedback provided by the SME can comprise corrections to response 1 generated by model 1. Training component 206 can convert the corrections into a negative signal (e.g., a penalty) and retrain model 1 on the negative signal. As illustrated in block C, retraining model 1 can generate new model 508 (e.g., an updated version of model 1), wherein new model 508 can generate a more accurate response (e.g., response 510) to prompt P1.

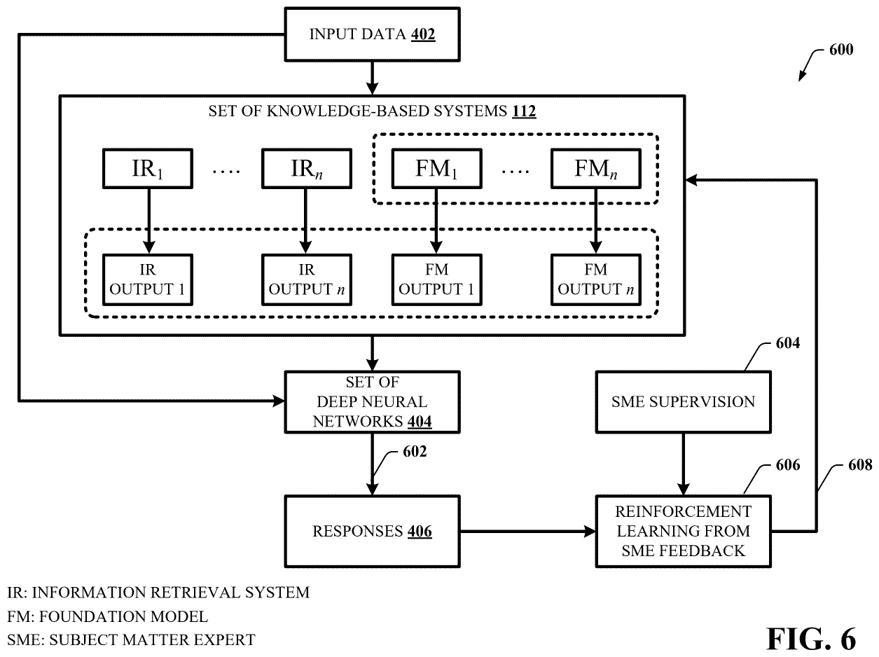

FIG. 6 illustrates a flow diagram of an example, non-limiting AI workflow 600 that can employ deep imitation learning to select optimal responses to prompts and that can employ deep imitation learning and reinforcement learning to train knowledge-based systems to generate optimal responses to prompts, in accordance with one or more embodiments described herein. Repetitive description of like elements and/or processes employed in respective embodiments is omitted for sake of brevity.

With continued reference to FIGS. 4 and 5, non-limiting AI workflow 600 summarizes the embodiments described by non-limiting methods 400 and 500. As illustrated, in one or more embodiments, set of knowledge-based systems 112 can comprise IR systems IR₁, . . . , IRₙ and foundation models FM₁, . . . , FMₙ. IR output 1, . . . , IR output n can be the respective responses generated by IR₁, . . . , IRₙ, and FM output 1, . . . , FM output n can be the respective responses generated by FM₁, . . . , FMₙ. At 602, set of deep neural networks 404 can select, based on input data 402, responses 406 from a collection of responses generated by set of knowledge-based systems 112 from prompts comprised within input data 402.

At 604 in non-limiting AI workflow 600, prompt component 212 can prompt SMEs to provide raw feedback (i.e., SME supervision) on responses 406. Data aggregation component 216 can aggregate raw feedback over time from multiple SMEs, pre-process the raw feedback, and convert the raw feedback into feedback data 126.

At 606 in non-limiting AI workflow 600, training component 206 can convert feedback data 126 into reward signals 128 and train, via reinforcement learning, one or more knowledge-based systems comprised within set of knowledge-based systems 112 on reward signals 128. For example, training component 206 can employ reward signals 128 to retrain FM₁ on responses 406 and on feedback data based on supervision from the SMEs.

At 608 in non-limiting AI workflow 600, FM₁ can be replaced with the retrained FM₁ by training component 206 or another component comprised within deep imitation learning model 110. As described elsewhere herein, training component 206 can also train set of deep neural networks 404 on feedback data 126 to select more optimal (e.g., accurate) responses to prompts.

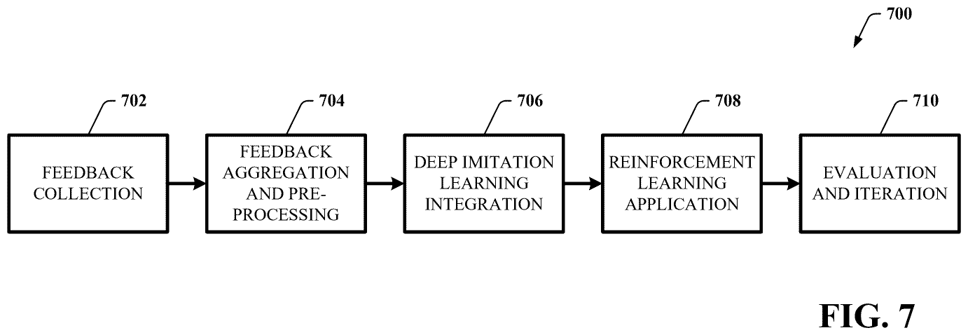

FIG. 7 illustrates a flow diagram of an example, non-limiting AI workflow 700 that can train a set of deep neural networks to employ deep imitation learning to select optimal responses to prompts and that can train knowledge-based systems to generate optimal responses to prompts, in accordance with one or more embodiments described herein. Repetitive description of like elements and/or processes employed in respective embodiments is omitted for sake of brevity.

Non-limiting AI workflow 700 describes a reduction to practice of the various embodiments of the present disclosure with continued reference to at least FIGS. 1 and 2.

At 702, non-limiting AI workflow 700 can comprise feedback collection. Within the feedback collection workflow, prompt component 212 can collect feedback from end entities (e.g., hardware, software, machines, AI, neural networks and/or users) on response 122. For example, an end entity (e.g., hardware, software, machine, AI, neural network and/or user) can interact with an LLM comprised within set of knowledge-based systems 112 via the UI of a computing device (e.g., a desktop computer, a laptop, a tablet, a smartphone, etc.). For example, the end entity (e.g., hardware, software, machine, AI, neural network and/or user) can provide input data 120 to system 102 to generate a response to a prompt comprised within input data 120. Based on the prompt, the LLM can generate response 122. Response 122 and other responses generated by models comprised within set of knowledge-based systems 112 can be stored by storage component 214 in a storage system (e.g., memory 106) as collection of responses 124. Based on input data 120, response selection component 204 can select response 122 as the optimal response for the prompt, and response selection component 204 can output response 122 on the UI. Upon receiving response 122 from response selection component 204, the end entity (e.g., hardware, software, machine, AI, neural network and/or user) and/or other end entities (e.g., hardware, software, machines, AI, neural networks and/or users) can be prompted by prompt component 212 to provide raw feedback on response 122 (e.g., via the UI or additional UIs of different computing systems). In one or more embodiments, the end entities (e.g., hardware, software, machines, AI, neural networks and/or users) can be SMEs, and the raw feedback provided by different end entities (e.g., hardware, software, machines, AI, neural networks and/or users) can comprise ratings, corrections, qualitative feedback and/or other suitable forms of feedback. Prompt component 212 can employ suitable mechanisms to record prompts (e.g., end entity queries/user queries), LLM responses and the raw feedback (e.g., end entity feedback/user feedback), and storage component 214 can store the prompt, response 122 and the corresponding raw feedback in a storage (e.g., memory 106) in a structured format.

At 704, non-limiting AI workflow 700 can comprise feedback aggregation and pre-processing. Within the feedback aggregation and pre-processing workflow, data aggregation component 216 can employ data aggregation tools to aggregate the raw feedback from multiple end entities (e.g., hardware, software, machines, AI, neural networks and/or users) over time. Further, data aggregation component 216 can employ pre-processing pipelines to pre-process the aggregated raw feedback to identify common trends, errors and specific areas where the performance of the LLM can be enhanced. Data aggregation component 216 can convert the raw feedback data from a first format unsuitable for training models into a second format suitable for training models. For example, data aggregation component 216 can convert qualitative feedback on response 122 from its original format into a format employable for training models. For example, data aggregation component 216 can convert a corrected response provided by an SME into a training pair comprising the prompt and the corrected response.

At 706, non-limiting AI workflow 700 can comprise deep imitation learning integration. Within the deep imitation learning integration workflow, training component 206 can retrain the set of deep neural networks comprised within response selection component 204 by employing the pre-processed feedback comprised within feedback data 126 as trajectories of decision sequences employed by the SMEs (e.g., expert trajectories) to provide the raw feedback on response 122. As a result, the set of deep neural networks can learn to imitate, via deep imitation learning, the corrections and the decision sequences provided by the SMEs more accurately and to predict which ones of the responses comprised within collection of responses 124 are optimal given a prompt and a corresponding context.

At 708, non-limiting AI workflow 700 can comprise a reinforcement learning application. Within the reinforcement learning application workflow, training component 206 can convert feedback data 126 into reward signals 128. For example, training component 206 can convert positive feedback comprised within feedback data 126 into positive rewards, and negative feedback/corrections comprised within feedback data 126 into negative rewards (e.g., negative penalties). Further, training component 206 can employ reward signals 128 to train the LLM, via reinforcement learning, to guide the LLM towards generating responses that align more closely with the SME preferences indicated by feedback data 126. Training component 206 can implement the reinforcement learning via suitable reinforcement learning algorithms such as DQN, PPO, SAC, TD3, A3C, etc. Additionally, training component 206 can iterate upon the training process to continuously refine the LLM based on an evolving understanding of what constitutes a good (e.g., optimal or accurate) response for a given prompt.

At 710, non-limiting AI workflow 700 can comprise evaluation and iteration. Within the evaluation and iteration workflow, evaluation component 208 can evaluate the performance of the LLM on test data 130, subsequent to the retraining of the LLM, to ensure that the performance of the LLM has improved. Test data 130 can be employed to test the performance of the LLM via holdout validation or A/B testing. In holdout validation, test data 130 can be a held-out testing dataset comprising data from feedback data 126 previously unseen by the LLM. Evaluation component 208 can employ various performance metrics and benchmarks to evaluate the performance of the LLM. Additionally, data aggregation component 216 can continuously monitor user satisfaction and feedback, and if there is any room for improvement in the LLM's performance, the LLM can undergo further refinement, and the feedback collection can begin anew. For example, subsequent to the testing of the LLM, the LLM can be employed to generate new responses for new prompts, and data aggregation component 216 can identify common trends, errors and areas of performance improvements for the LLM by pre-processing raw feedback collected by prompt component 212 on the new responses. If new or additional areas of performance improvements are identified by data aggregation component 216 for the LLM, training component 206 can automatically refine (e.g., update or retrain) the LLM, and the collection of raw feedback by feedback component 210 can automatically begin anew. Thus, in one or more embodiments, the LLM and one or more additional models comprised within set of knowledge-based systems 112 can be iteratively updated via automated training loops.

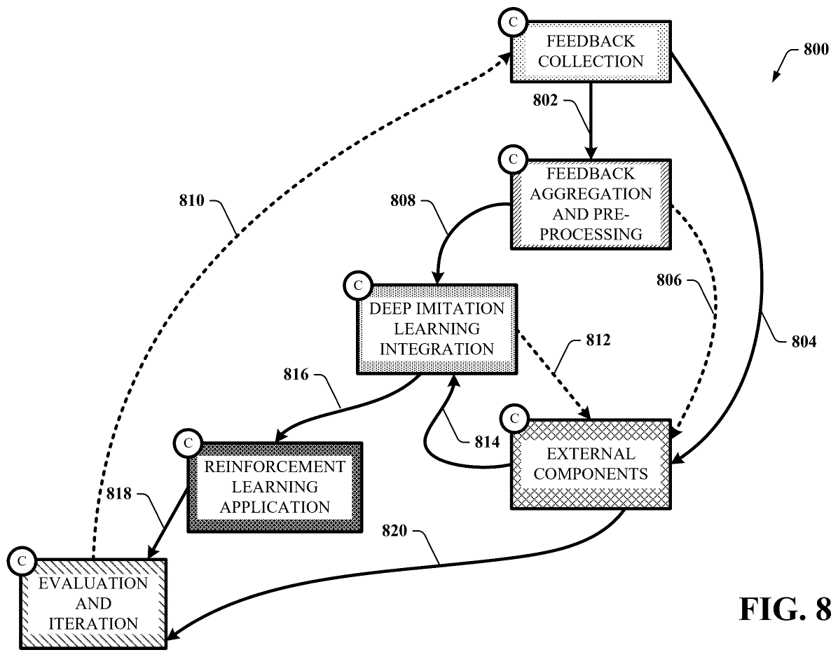

FIG. 8 illustrates another flow diagram of an example, non-limiting AI workflow 800 that can train a set of deep neural networks to employ deep imitation learning to select optimal responses to prompts and that can train knowledge-based systems to generate optimal responses to prompts, in accordance with one or more embodiments described herein. Repetitive description of like elements and/or processes employed in respective embodiments is omitted for sake of brevity.

Non-limiting AI workflow 800 can be analogous to non-limiting AI workflow 700 of FIG. 7 and illustrates additional aspects of non-limiting AI workflow 700. Non-limiting AI workflow 800 can also represent a component diagram for non-limiting AI workflow 700.

At 802 in non-limiting AI workflow 800, subsequent to the initial stage of raw feedback collection (e.g., at 702 in non-limiting AI workflow 700), data aggregation component 216 can access the raw feedback in addition to the prompts and responses corresponding to the raw feedback for feedback aggregation and pre-processing (e.g., at 704 in non-limiting AI workflow 700).

At 808 in non-limiting AI workflow 800, feedback data 126 generated by data aggregation component 216 based on the raw feedback can be accessed by training component 206 to retrain response selection component 204 to learn by demonstration (e.g., at 706 in non-limiting AI workflow 700).

At 816 in non-limiting AI workflow 800, feedback data 126 can be further employed to retrain one or more foundation models or other models comprised within set of knowledge-based systems 112 to fine-tune and guide the models, via reinforcement learning based on reward signals 128, towards selecting more optimal data (e.g., from external sources such as online libraries, publications, etc.) and generating more accurate responses to prompts (e.g., at 708 in non-limiting AI workflow 700).

At 818 in non-limiting AI workflow 800, the trained models can be accessed by evaluation component 208 and training component 206 to test the respective performances of the trained models on test data 130 via A/B testing or holdout validation testing and to perform continuous evaluation and improvements on the trained models via automated training loops (e.g., at 710 in non-limiting AI workflow 700).

At 810 in non-limiting AI workflow 800, feedback component 210 can reinitiate the feedback loop to collect new raw feedback after the models are retrained by training component 206.

At 804 in non-limiting AI workflow 800, the raw feedback from the initial stage of raw feedback collection can be accessed by external components for additional processing.

At 806 in non-limiting AI workflow 800, feedback data 126 that is updated by data aggregation component 216 based on new raw feedback can be accessed by the external components.

At 812 in non-limiting AI workflow 800, training component 206 can request more expert insights from the external components based on feedback data 126 (e.g., user feedback, expert feedback, training data).

At 814 in non-limiting AI workflow 800, the external components can offer the expert insights to training component 206.

At 820 in non-limiting AI workflow 800, the external components can deliver test cases (e.g., test data 130) to evaluation component 208, wherein the test cases can be employed by evaluation component 208 to test the respective performances of the models comprised within set of knowledge-based systems 112.

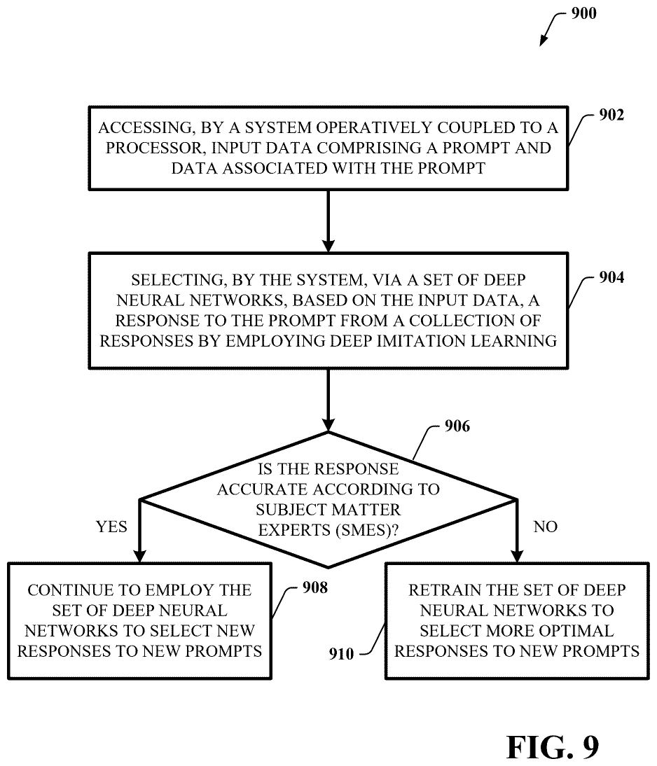

FIG. 9 illustrates a flow diagram of an example, non-limiting method 900 that can employ deep imitation learning to select optimal responses to prompts and that can employ deep imitation learning and reinforcement learning to train knowledge-based systems to generate optimal responses to prompts, in accordance with one or more embodiments described herein. Repetitive description of like elements and/or processes employed in respective embodiments is omitted for sake of brevity.

At 902, non-limiting method 900 can comprise accessing (e.g., by access component 202), by a system operatively coupled to a processor, input data comprising a prompt and data associated with the prompt.

At 904, non-limiting method 900 can comprise selecting (e.g., by response selection component 204), by the system, via a set of deep neural networks, based on the input data, a response to the prompt from a collection of responses by employing deep imitation learning.

At 906, non-limiting method 900 can comprise determining (e.g., by data aggregation component 216), by the system, whether the response is accurate according to SMEs (e.g., based on raw feedback provided by SMEs for the response).

If yes, then at 908, non-limiting method 900 can comprise employing (e.g., by response selection component 204), by the system, the set of deep neural networks to select new responses to new prompts.

If not, then at 910, non-limiting method 900 can comprise retraining (e.g., by training component 206), by the system, the set of deep neural networks to select more optimal responses to new prompts.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ AI to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence(class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

FIG. 10 illustrates a block diagram of an example, non-limiting, operating environment 1000 in which one or more embodiments described herein can be facilitated. FIG. 10 and the following discussion are intended to provide a general description of a suitable operating environment 1000 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as deep imitation learning code 1028. In addition to block 1028, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1028, as identified above), peripheral device set 1014 (including user interface (UI) device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer-readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1028 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, volatile memory 1012 is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface-type operating systems that employ a kernel. The code included in block 1028 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer-readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN 1002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

CLOUD COMPUTING SERVICES AND/OR MICROSERVICES (not separately shown in FIG. 10): private and public clouds 1006 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer-executable components;
a processor that executes the computer-executable components stored in the memory, wherein the computer-executable components comprise:
an access component that accesses input data comprising a prompt and data associated with the prompt; and
a response selection component that selects, based on the input data, a response to the prompt from a collection of responses by employing deep imitation learning.

2. The system of claim 1, wherein the response selection component comprises a set of deep neural networks, and wherein the system further comprises:
a training component that trains the response selection component to select the response, wherein training the response selection component comprises:
accessing, by the training component, feedback data associated with one or more responses previously selected by the response selection component from the collection of responses, wherein the one or more responses comprise responses generated by a large language model (LLM) based on one or more past prompts, and wherein the feedback data comprises trajectories of decision sequences employed by one or more subject matter experts (SMEs) based on the one or more past prompts; and
training, by the training component, the set of deep neural networks to imitate decision sequences comprised within the trajectories of decision sequences by employing the feedback data as training data.

3. The system of claim 2, wherein the training component further trains the LLM, wherein training the LLM comprises:
converting, by the training component, the feedback data into reward signals, such that positive feedback comprised within the feedback data is converted to positive signals, and negative feedback comprised within the feedback data is converted to negative signals; and
training, by the training component, the LLM, wherein the LLM is trained iteratively, based on the reward signals, via the deep imitation learning and reinforcement learning.

4. The system of claim 3, further comprising:
an evaluation component that evaluates a performance of the LLM, subsequent to the training of the LLM, by testing the performance of the LLM on test data via A/B testing or holdout validation testing.

5. The system of claim 2, further comprising:
a feedback component that generates the feedback data, wherein generating the feedback data comprises:
prompting, by a prompt component, the one or more SMEs for raw feedback on the one or more responses;
storing, by a storage component, the one or more past prompts, the one or more responses and the raw feedback in a structured format;
aggregating, by a data aggregation component, the raw feedback from the one or more SMEs;
pre-processing, by the data aggregation component, the raw feedback to identify common trends, errors and areas of performance improvements for the LLM; and
converting, by the data aggregation component, a first format associated with the raw feedback into a second format employable by the training component to train the set of deep neural networks.

6. The system of claim 1, wherein the collection of responses comprises respective responses generated by respective models comprised within a set of knowledge-based systems.

7. The system of claim 6, wherein the set of knowledge-based systems comprises one or more foundation models.

8. The system of claim 6, wherein the set of knowledge-based systems comprises one or more information retrieval models.

9. A computer-implemented method, comprising:
accessing, by a system operatively coupled to a processor, input data comprising a prompt and data associated with the prompt; and
selecting, by the system, via a set of deep neural networks, based on the input data, a response to the prompt from a collection of responses by employing deep imitation learning.

10. The computer-implemented method of claim 9, further comprising:
training, by the system, the set of deep neural networks to select the response, wherein the training the set of deep neural networks comprises:
accessing, by the system, feedback data associated with one or more responses previously selected by the set of deep neural networks from the collection of responses, wherein the one or more responses comprise responses generated by one or more LLMs based on one or more past prompts, and wherein the feedback data comprises trajectories of decision sequences employed by one or more SMEs based on the one or more past prompts; and
training, by the system, the set of deep neural networks to imitate decision sequences comprised within the trajectories of decision sequences by employing the feedback data as training data.

11. The computer-implemented method of claim 10, further comprising:
training, by the system, the one or more LLMs, wherein the training the one or more LLMs comprises:
converting, by the system, the feedback data into reward signals, such that positive feedback comprised within the feedback data is converted to positive signals, and negative feedback comprised within the feedback data is converted to negative signals; and
training, by the system, the one or more LLMs, wherein the one or more LLMs are trained iteratively, based on the reward signals, via the deep imitation learning and reinforcement learning.

12. The computer-implemented method of claim 11, further comprising:
evaluating, by the system, respective performances of the one or more LLMs, subsequent to the training of the one or more LLMs, by testing the respective performances of the one or more LLMs on test data via A/B testing or holdout validation testing.

13. The computer-implemented method of claim 10, wherein
generating, by the system, the feedback data, wherein the generating the feedback data comprises:
prompting, by the system, the one or more SMEs for raw feedback on the one or more responses;
storing, by the system, the one or more past prompts, the one or more responses and the raw feedback in a structured format;
aggregating, by the system, the raw feedback from the one or more SMEs;
pre-processing, by the system, the raw feedback to identify common trends, errors and areas of performance improvements for the one or more LLMs; and
converting, by the system, a first format associated with the raw feedback into a second format employable by the system to train the set of deep neural networks.

14. The computer-implemented method of claim 9, wherein the collection of responses comprises respective responses generated by respective models comprised within a set of knowledge-based systems.

15. The computer-implemented method of claim 14, wherein the set of knowledge-based systems comprises one or more foundation models.

16. The computer-implemented method of claim 14, wherein the set of knowledge-based systems comprises one or more information retrieval models.

17. A computer program product for selecting optimal responses to prompts via imitation deep learning, the computer program product comprising a computer readable storage medium having program instructions embodied therewith, the program instructions executable by a processor to cause the processor to:
access, by the processor, input data comprising a prompt and data associated with the prompt; and
select, by the processor, via a set of deep neural networks, based on the input data, a response to the prompt from a collection of responses by employing deep imitation learning.

18. The computer program product of claim 17, wherein the program instructions are further executable by the processor to cause the processor to:
train, by the processor, the set of deep neural networks to select the response, wherein training the set of deep neural networks comprises:
accessing, by the processor, feedback data associated with one or more responses previously selected by the set of deep neural networks from the collection of responses, wherein the one or more responses comprise responses generated by a foundation model based on one or more past prompts, and wherein the feedback data comprises trajectories of decision sequences employed by one or more SMEs based on the one or more past prompts; and
training, by the processor, the set of deep neural networks to imitate decision sequences comprised within the trajectories of decision sequences by employing the feedback data as training data.

19. The computer program product of claim 18, wherein the program instructions are further executable by the processor to cause the processor to:
train, by the processor, the foundation model, wherein training the foundation model comprises:
converting, by the processor, the feedback data into reward signals, such that positive feedback comprised within the feedback data is converted to positive signals, and negative feedback comprised within the feedback data is converted to negative signals; and
training, by the processor, the foundation model, wherein the foundation model is trained iteratively, based on the reward signals, via the deep imitation learning and reinforcement learning.

20. The computer program product of claim 18, wherein the program instructions are further executable by the processor to cause the processor to:
evaluate, by the processor, a performance of the foundation model, subsequent to the training of the foundation model, by testing the performance of the foundation model on test data via A/B testing or holdout validation testing.
